(19) United States
(12) Patent Application Publication
(10) Pub. No.: US 2017/0019912 A1
(43) Pub. Date: Jan. 19, 2017

(54) System Information Decoding in Multi-Subscription Multi-Standby Communication Devices

(71) Applicant: QUALCOMM Incorporated, San Diego, CA (US)

(72) Inventors: Dhananjaya Sarma Ponukumati, Hyderabad (IN); Satish Pavan Kumar Nichanametla, Hyderabad (IN)

(21) Appl. No.: 14/798,552

(22) Filed: Jul. 14, 2015

(51) Int. Cl. H04W 72/12

(52) U.S. Cl. CPC H04W 72/1215; H04W 88/06

(57) ABSTRACT

Embodiments include systems and methods for managing reception of system information transmissions from networks of a first subscription and a second subscription by a processor of a multi-subscription multi-standby communication device. The device processor may identify which of the first subscription and the second subscription has a lower rate of system information transmissions. The device processor may determine whether a next scheduled system information transmission by each of the first and second subscriptions will collide. The device processor may receive the next system information transmission from the subscription identified as having the lower repetition rate of system information transmissions in response to determining that the next scheduled system information transmission by each of the first and second subscriptions will collide.

### BACKGROUND

Wireless devices having multiple subscriber identity modules (SIMs) may communicate with two or more cells of a wireless network. Some multi-subscription multi-standby communication devices may allow two or more network interfaces or subscriber identity modules (SIMs) to share a single radio frequency (RF) resource (e.g., dual-SIM dual-standby, or “DSDS” devices). However, the RF resource in such devices can only tune to a single network at a time. The multi-subscription multi-standby communication device may employ a “tune-away” procedure to monitor multiple interfaces in a standby mode by tuning to one network in a primary cell, quickly tuning away to the second network in a second cell for a short time, and then tuning back to the first network to continue a voice or data call. This tune-away procedure may allow the multi-subscription multi-standby communication device to monitor for pages or other indications of incoming messages or data received on the second network. However, tuning away to another network may interrupt communications with the first network, and may reduce throughput of communications between the first network and the multi-subscription multi-standby communication device.

The multi-subscription multi-standby communication device may also use a tune-away procedure to monitor signals other than bearer or control signals from two or more communication networks. For example, base stations of wireless communication networks may broadcast system information messages, such as master information blocks (MIBs) and system information blocks (SIBs), which the multi-subscription multi-standby communication device may use to establish communication with a particular base station, such as during cell selection or cell reselection. For example, system information messages may include scheduling information, a frame offset indication, a number of segments, a repetition rate of system information, and other information that the multi-subscription multi-standby communication device may use to establish communication with a base station. Failure to decode or incomplete decoding of system information (e.g., an MIB or SIB) may cause the multi-subscription multi-standby communication device to fail to establish communication with a base station (i.e., to become out of service).

Base stations associated with different communication networks may transmit system information according to different schedules, and the system information of different base stations may be transmitted such that they overlap in time in whole or in part (i.e., the different system information may collide).

### SUMMARY

Systems, methods, and devices of various embodiments enable a mobile communication device to manage reception of system information transmissions from networks of a first subscription and a second subscription. Various embodiments may include identifying which of the first subscription and the second subscription has a lower repetition rate of system information transmissions, determining whether a next scheduled system information transmission by each of the first and second subscriptions will collide, and receiving the next system information transmission from the subscription identified as having the lower repetition rate of system information transmissions in response to determining that the next scheduled system information transmission by each of the first and second subscriptions will collide.

In various embodiments, identifying which of the first subscription and the second subscription has a lower rate of system information transmissions may include receiving a schedule of first system information transmissions associated with a first subscription and a schedule of second system information transmissions associated with a second subscription, determining a first repetition rate of the first system information transmissions based on the schedule of first system information transmissions, determining a second repetition rate of the system information transmissions associated with the second subscription based on the schedule of second system information transmissions, and comparing the first repetition rate to the second repetition rate.

In various embodiments, receiving the next system information transmission from the subscription identified as having the lower repetition rate may include tuning a shared radio frequency resource of the multi-subscription multi-standby device to the subscription during the next scheduled system information transmission. In various embodiments, the system information transmissions for the first and second subscriptions may include master information block (MIB) transmissions. In various embodiments, the system information transmissions for the first and second subscriptions may include system information block (SIB) transmissions.

Various embodiments may further include receiving the next system information transmission from one of the first subscription and the second subscription in response to determining that the next scheduled system information transmission by each of the first and second subscriptions will not collide. In various embodiments, receiving the next system information transmission from the subscription identified as having the lower repetition rate may include receiving the next system information transmission associated with the subscription having the lower repetition rate of system information transmissions.

Various embodiments may include a mobile communication device including a processor configured with processor-executable instructions to perform operations of the embodiment methods described above. Various embodiments may include a non-transitory processor-readable storage medium having stored thereon processor-executable software instructions configured to cause a processor to perform operations of the embodiment methods described above. Various embodiments may include a mobile communication device that includes means for performing functions of the operations of the embodiment methods described above.

### BRIEF DESCRIPTION OF THE DRAWINGS

The accompanying drawings, which are incorporated herein and constitute part of this specification, illustrate exemplary embodiments. Together with the general description given above and the detailed description given below, the drawings serve to explain features of the various embodiments, and not to limit the various embodiments.

FIG. 1 is a component block diagram of a communication system suitable for use with various embodiments.

FIG. 2 is a component block diagram of a multi-subscription multi-standby communication device according to various embodiments.

FIG. 3 is a diagram illustrating exemplary schedules of system information broadcasts according to various embodiments.

FIG. 4 is a process flow diagram illustrating a method for decoding system information received by a processor of a multi-subscription multi-standby communication device according to various embodiments.

FIG. 5 is a component block diagram of a mobile communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods implemented in multi-subscription multi-standby communication devices that enable decoding of system information of a plurality of communication networks received by a processor of a multi-subscription multi-standby communication device that reduces the time required to receive the system information of all communication networks.

The terms “multi-subscription multi-standby communication device,” “wireless device,” “communication device,” and “mobile communication device” are used interchangeably herein to refer to any one or all of cellular telephones, smartphones, personal or mobile multi-media players, personal data assistants, laptop computers, tablet computers, smartbooks, palmtop computers, wireless electronic mail receivers, multimedia Internet enabled cellular telephones, wireless gaming controllers, and similar electronic devices and portable computing platforms which include a programmable processor, memory and a shared radio frequency (RF) resource. Various embodiments may be particularly useful in any communication devices that can support multiple wireless wide area network subscriptions and receive cell broadcasts via the shared RF resource.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

References to “first network,” “first subscription,” “second network,” and “second subscription” are arbitrary and are used to refer to two or more subscriptions/networks generally because at any given time either subscription/network may be in an active mode (on an active voice or data call) or a standby mode, and all subscriptions/networks may need to monitor for system information (e.g., for network SIB transmissions). For example, one minute a GSM subscription with a GSM network may be on an active data call (and thus a “first subscription) while a WCDMA subscription with a WCDMA network is in the standby mode (and thus a “second” subscription), and the next minute the WCDMA subscription may enter an active data call (becoming the “first” subscription) and the GSM subscription may enter the standby mode (becoming the “second” subscription).

Also, references to “first” and “second” subscriptions and networks is not intended to imply that the embodiments are limited to two subscriptions sharing one RF resource, because three or more subscriptions may share one RF resource provided that only one subscription can use the RF resource at a time. Third and fourth subscriptions would behave similar to a second subscription. Therefore, in the interest of brevity, operations of subscriptions in the standby mode that share the RF resource during tune-away periods are described generally with reference to the “second” subscription.

A multi-subscription multi-standby communication device may use a tune-away procedure to monitor for pages or other indications of incoming messages or data received on the second network, and to monitor signals other than bearer or control signals from two or more networks. For example, base stations of wireless communication networks may broadcast system information messages, such as MIBs and SIBs, which the multi-subscription multi-standby communication device may use to establish communication with a particular base station, such as during cell selection or cell reselection. System information messages may include scheduling information, a frame offset indication, a number of segments, a repetition rate of system information, and other information that the multi-subscription multi-standby communication device may use to establish communication with a base station. Failure to decode or incomplete decoding of system information (e.g., an MIB or SIB) may cause the multi-subscription multi-standby communication device to fail to establish communication with a base station (i.e., to become out of service).

In some embodiments, after initial cell synchronization, a multi-subscription multi-standby communication device may receive MIB, which provides the mobile communication device with information to receive various SIBs, including scheduling information, a frame offset, a number of segments, and a repetition rate. If the multi-subscription multi-standby communication device does not completely decode the SIBs, the multi-subscription multi-standby communication device could fail to establish communication with the base station. In some embodiments, a SIB read time may last as long as 1.5 to 2 seconds.

Base stations associated with different communication networks may transmit system information according to different schedules and, as a result, the system information of different base stations may be transmitted such that they partially or wholly overlap in time (i.e., the different system information messages “collide”). When the multi-subscription multi-standby communication device detects a collision of system information transmissions (e.g., MIB or SIB transmissions), the multi-subscription multi-standby communication device selects one subscription to receive its system information because the shared RF resource can only tune to one network at a time. In conventional systems, the multi-subscription multi-standby communication device may select for reception the system information of a relatively higher priority subscription. However, if the system information of the relatively lower priority subscription is transmitted less frequently than the system information of the relatively higher priority subscription, the multi-subscription multi-standby communication device may experience a substantial delay in receiving the system information of the other (i.e., relatively lower priority) subscription. This may lead to extended delays in receiving system information for all subscriptions, and may further cause the multi-subscription multi-standby communication device to go out of service with one or more communication networks.

Various embodiments enable a processor of a multi-subscription multi-standby communication device to decode system information from two or more communication networks in a manner that reduces a delay time of receiving system information from all of the communication networks, in particular when the system information transmissions from two or more communication networks overlap in time (i.e., “collide”). In some embodiments, the processor of the multi-subscription multi-standby communication device may manage the reception of system information transmissions when a collision is anticipated in order to enable faster reception of the system information from two or more communication networks. In some embodiments, the processor may determine that a collision of system information transmissions for two or more subscriptions will occur, and the processor may select for reception the system information transmissions that are broadcast less frequently (e.g., have a lower repetition rate, or have a greater interval of time between system information transmissions). The non-selected system information transmission may then be received at its next transmission time because the transmission rates of the two subscriptions are different (i.e., they do not collide), and the next system information transmission in time will be the more frequently transmitted system information. This simple algorithm for selecting one of two or more colliding system information transmissions for reception thus enable the multi-subscription multi-standby communication device to receive system information from both or all subscriptions in the shortest time possible.

In some embodiments, the multi-subscription multi-standby communication device may receive a master information block (MIB) for each of two or more signals, each signal associated with a subscription of the mobile communication device. Each MIB in a signal may provide, among the things, a repetition rate or broadcast periodicity of the SIBs for the signal. The multi-subscription multi-standby communication device may use the SIB transmission periodicity to identify when two or more SIBs will collide. When a SIB collision is recognized, multi-subscription multi-standby communication device may select for reception during the collision the signal having the lowest SIB repetition rate (i.e., the signal with the most time between transmissions of the SIBs), and the multi-subscription multi-standby communication device may receive the SIB of the selected signal.

For example, if a first signal has a first SIB repetition rate of a transmission every 1280 ms and a second signal has a second SIB repetition rate of a transmission every 160 ms, the multi-subscription multi-standby communication device may select the first signal and receive the first signal's SIBs during the collision, because doing so may cause a delay of no more than 160 ms before the second signal's SIBs can be received. In contrast, if the second signal was selected for reception during the collision there may be a delay of up to 1280 ms before the system information from both networks is received by the multi-subscription multi-standby communication device.

Thus, when a multi-subscription multi-standby communication device detects that system information transmissions of two or more networks (subscriptions) overlap in time (collides), the multi-subtraction multi-standby communication device may tune away to receive the system information transmission from the network (subscription) whose system information transmissions are repeated less frequently (i.e., that has a lower repetition rate, or a greater interval of time between transmissions of its system information). Thus, the multi-subscription multi-standby communication device may detect when system information transmissions for the first and second signal collide, and in response, the multi-subscription multi-standby communication device may select one of the system information blocks to receive based on their respective repetition rates.

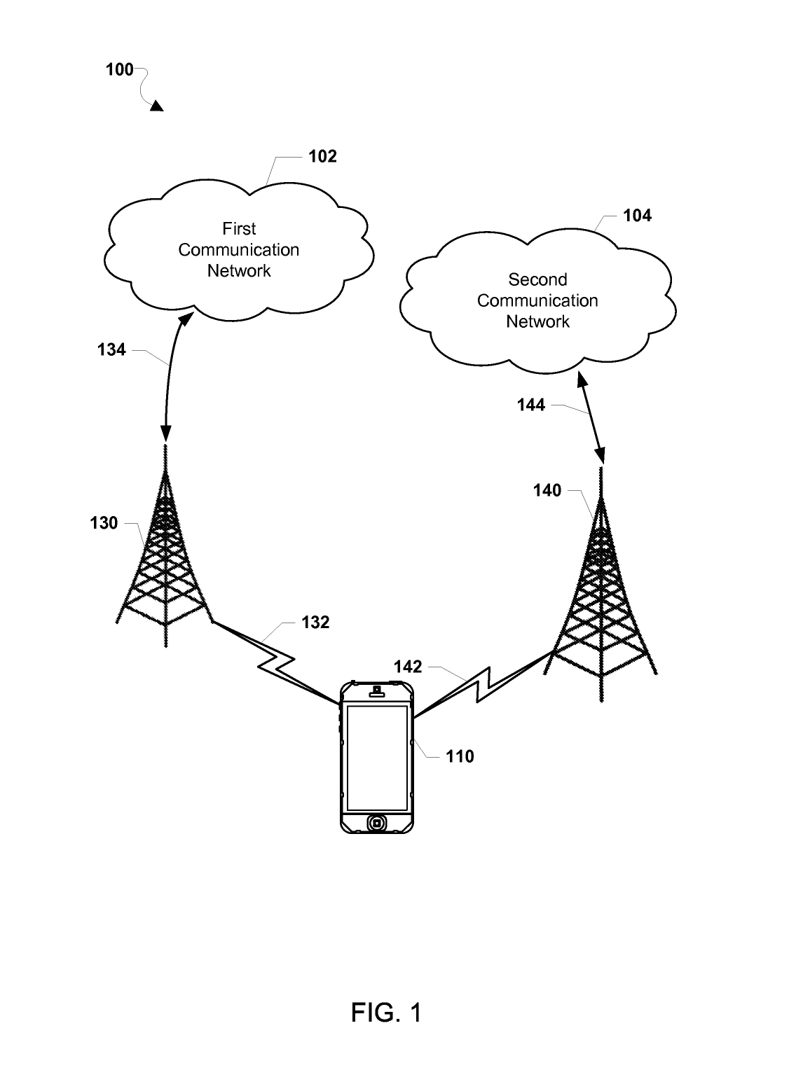

Various embodiments may be implemented within a variety of communication systems 100, such as systems that include at least two mobile communication networks, an example of which is illustrated in FIG. 1. A first communication network 102 and a second communication network 104 each may include a plurality of cellular base stations (e.g., a first base station 130 and a second base station 140). A multi-subscription multi-standby communication device 110 may communicate with the first communication network 102 through a communication link 132 to the first base station 130. The first mobile communication device 110 may also communicate with the second mobile network 104 through a communication link 142 to the second base station 140. The first base station 130 may communicate with the first communication network 102 over a wired or wireless communication link 134, and the second base station 140 may communicate with the second communication network 104 over a wired or wireless communication link 144. The communication links 134 and 144 may include fiber optic backhaul links, microwave backhaul links, and other similar communication links.

Each of the communication networks 102 and 104 may support communications using one or more radio access technologies, and each of the communication links 132, 134, 142, and 144 may include cellular connections that may be made through two-way wireless communication links using one or more radio access technologies (RATs). Examples of RATs may include 3GPP Long Term Evolution (LTE), Worldwide Interoperability for Microwave Access (WiMAX), Code Division Multiple Access (CDMA), Time Division Multiple Access (TDMA), Wideband CDMA (WCDMA), Global System for Mobility (GSM), and other RATs. While the communication links 132, 134, 142, and 144 are illustrated as single links, each of the communication links may include a plurality of frequencies or frequency bands, each of which may include a plurality of logical channels. Additionally, each of the communication links 132, 134, 142, and 144 may utilize more than one RAT.

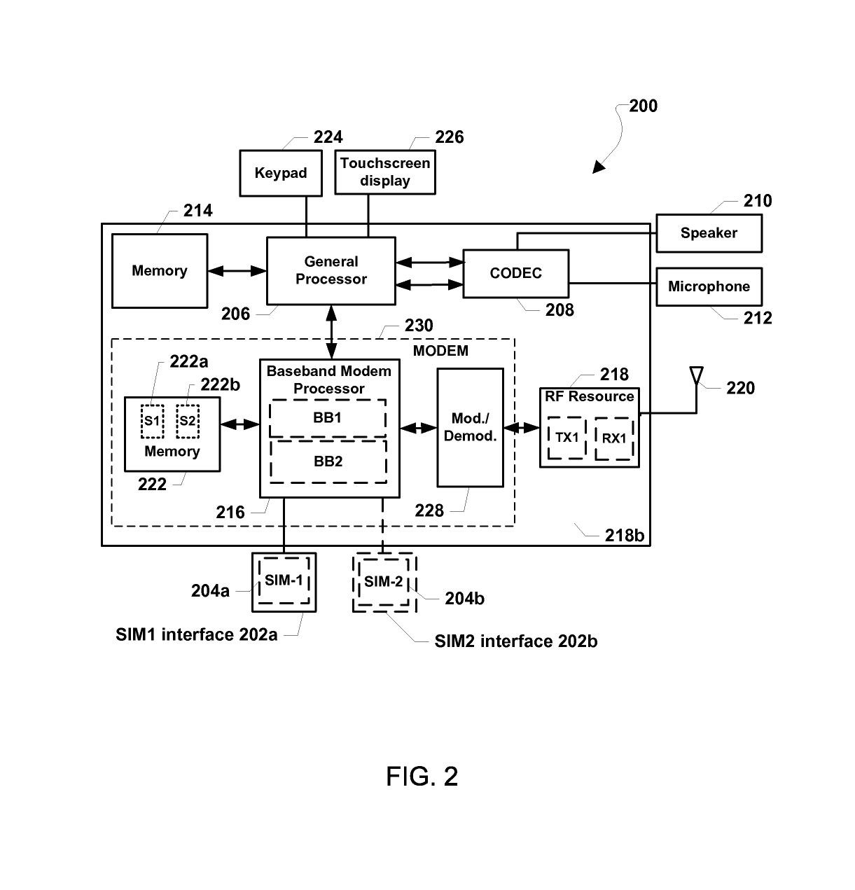

FIG. 2 is a component block diagram of a multi-subscription multi-standby communication device 200 suitable for implementing various embodiments. With reference to FIGS. 1 and 2, in various embodiments, the multi-subscription multi-standby communication device 200 may be similar to the multi-subscription multi-standby communication device 110. The multi-subscription multi-standby communication device 200 may include a first SIM interface 202a, which may receive a first identity module SIM-1 204a that is associated with a first subscription. The multi-subscription multi-standby communication device 200 may optionally also include a second SIM interface 202b, which may receive a second identity module SIM-2 204b that is associated with a second subscription.

A SIM in various embodiments may be a Universal Integrated Circuit Card (UICC) that is configured with SIM and/or USIM (Universal Subscriber Identity Module) applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The multi-subscription multi-standby communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general-purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to an RF resource 218 for transmission. The modulator/demodulator 228 may also extract an information-bearing signal from a modulated carrier wave received from the RF resource 218, and may provide the demodulated signal to the baseband modem processor 216. The modulator/demodulator 228 may be or include a digital signal processor (DSP).

The baseband modem processor 216 may read and write information to and from the memory 222. The memory 222 may also store instructions associated with a protocol stack, such as protocol stack S1 222a and protocol stack S2 222b. The protocol stacks S1 222a, S2 222b generally include computer executable instructions to enable communication using a radio access protocol or communication protocol. Each protocol stack S1 222a, S2 222b typically includes network protocol layers structured hierarchically to provide networking capabilities. The modem 230 may include one or more of the protocol stacks S1 222a, S2 222b to enable communication using one or more RATs. The protocol stacks S1 222a, S2 222b may be associated with a SIM card (e.g., SIM-1 204a, SIM-2 204b) configured with a subscription. For example, the protocol stack S1 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the multi-subscription multi-standby communication device 200 (e.g., SIM-1 204a, SIM-2 204b) may be coupled to the modem 230 and may be associated with or permitted to use an RF resource. The term “RF resource” is used herein to refer to all of the circuitry used to send and receive RF signals, which may include the baseband modem processor 216 that performs baseband/modem functions for communicating with/controlling a RAT, one or more radio units including transmitter and receiver components that are shown as RF resource 218 (e.g., in FIG. 2), one or more of the wireless antennas 220a, 220b, and additional circuitry that may include one or more amplifiers and radios. In some embodiments, the RF resource 218 may use a baseband modem processor 216 to perform baseband/modem functions for all RATs on the multi-subscription multi-standby communication device. In some embodiments, the RF resource may include the physically or logically separate baseband processors (e.g., BB1, BB2).

The RF resource 218 may include transceivers associated with one or more RATs and may perform transmit/receive functions for the mobile communication device 200 on behalf of their respective RATs. The RF resource 218 may include separate transmit and receive circuitry. The RF resource 218 may be coupled to a wireless antenna (e.g., the wireless antenna 220). The RF resource 218 may also be coupled to the baseband modem processor 216.

In some embodiments, the general-purpose processor 206, memory 214, baseband processor(s) 216, and the RF resource 218 may be included in the mobile communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the mobile communication device 200 may include, but are not limited to, a keypad 224 and a touchscreen display 226.

In some embodiments, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-subscription multi-standby communication device 200 to enable communication between them.

Functioning together, the two SIMs 204a, 204b, the baseband processor(s) 216, RF resource 218 and the antenna 220 may enable communications on two or more RATs. For example, one SIM, baseband processor, and RF resource may be configured to support two different RATs. In other embodiments, more RATs may be supported on the multi-subscription multi-standby communication device 200 by adding more SIM cards, SIM interfaces, RF resources, and antennas for connecting to additional mobile networks.

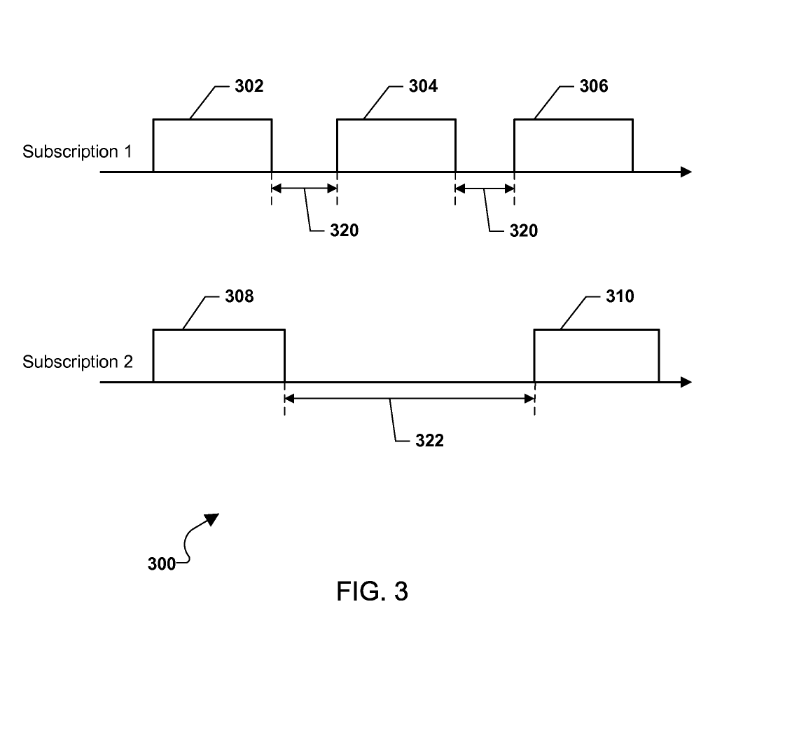

FIG. 3 is a diagram 300 illustrating exemplary schedules of system information broadcasts according to various embodiments. With reference to FIGS. 1-3, base stations associated with different communication networks (e.g., the base stations 130, 140) may transmit system information (e.g., MIB or SIB) according to different schedules. The system information of different base stations may be transmitted such that they overlap in whole or in part (i.e., the different system information may collide), which may cause a multi-subscription multi-standby communication device with a single radio resource to be unable to receive overlapping system information from one or more subscriptions. For example, the transmission of system information 302 of subscription 1 may collide with the transmission of system information 308 of subscription 2. The multi-subscription multi-standby communication device (e.g., the multi-subscription multi-standby communication device 110, 200) may detect the impending collision of system information transmissions 302 and 308. Because the multi-subscription multi-standby has a single radio resource, the multi-subscription multi-standby communication device selects one of subscription 1 and subscription 2 to receive the selected subscription's system information (i.e., system information 302 or system information 308, respectively).

Each subscription may have a different repetition rate of the transmission of its system information. For example, subscription 1 may transmit system information 302, 304, 306 with an intervening interval 320 between system information transmissions, while subscription 2 may transmit system information 308, 310 with an interval 322 between its system information transmissions. The repetition rate of system information transmissions of the different subscriptions may be different. For example, interval 320 is shorter than interval 322. Thus, subscription 1 has a higher rate of repetition of transmissions of its system information than subscription 2, which has a lower rate of repetition of its system information transmissions relative to subscription 1. In such circumstances, the system information transmissions of subscriptions 1 and 2 will occasionally overlap in time (i.e., collide).

In response to determining that a particular set of transmissions of system information 302 and system information 308 will collide, the multi-subscription multi-standby communication device may select to receive the system information of one of subscription 1 and subscription 2. If the multi-subscription multi-standby communication device elects to receive system information 302 of subscription 1 because subscription 1 is a relatively higher priority subscription, reception of the system information 310 of subscription 2 will be delayed because of the length of the interval 322 of subscription 2 (i.e., the multi-subscription multi-standby communication device waits until the next scheduled system information transmission of subscription 2). Thus, when the system information of the relatively lower priority subscription (i.e., subscription 2) is broadcast less frequently than the system information of the relatively higher priority subscription, the multi-subscription multi-standby communication device may experience a substantial delay in receiving the system information of the relatively lower priority subscription. This may lead to extended delays in receiving system information for all subscriptions, and this may further cause the multi-subscription multi-standby communication device to go out of service with one or more communication networks.

In contrast, if the multi-subscription multi-standby communication device elects to receive the system information for the subscription having the lower transmission rate of system information transmissions (e.g., SIBs are broadcast less frequently) when there is a collision (e.g., selects and receives system information 308 of subscription 2), then the multi-subscription multi-standby communication device need only wait until the end of the shorter interval 322 to receive system information 304 of subscription 1. Thus, by determining the repetition rates of the system information transmissions of each subscription and receiving the system information transmission associated with the subscription having the lower rate of repetition first in the event of a collision, the multi-subscription multi-standby communication device is able to receive system information from both subscriptions in the least total time.

While only two subscriptions are illustrated in the diagram 300, the multi-subscription multi-standby communication device may determine a repetition rate of system information from three or more subscriptions, and each time there is a collision of two or more system information transmissions, selectively tune to and receive the system information from the subscription with the lowest transmission repetition rate. In some embodiments, the multi-subscription multi-standby communication device may determine a repetition rate of each of three or more subscriptions and may rank the subscriptions according to their determined system information repetition rates. The multi-subscription multi-standby communication device may then tune to and receive the system information of each of the three or more subscriptions in order of the ranking.

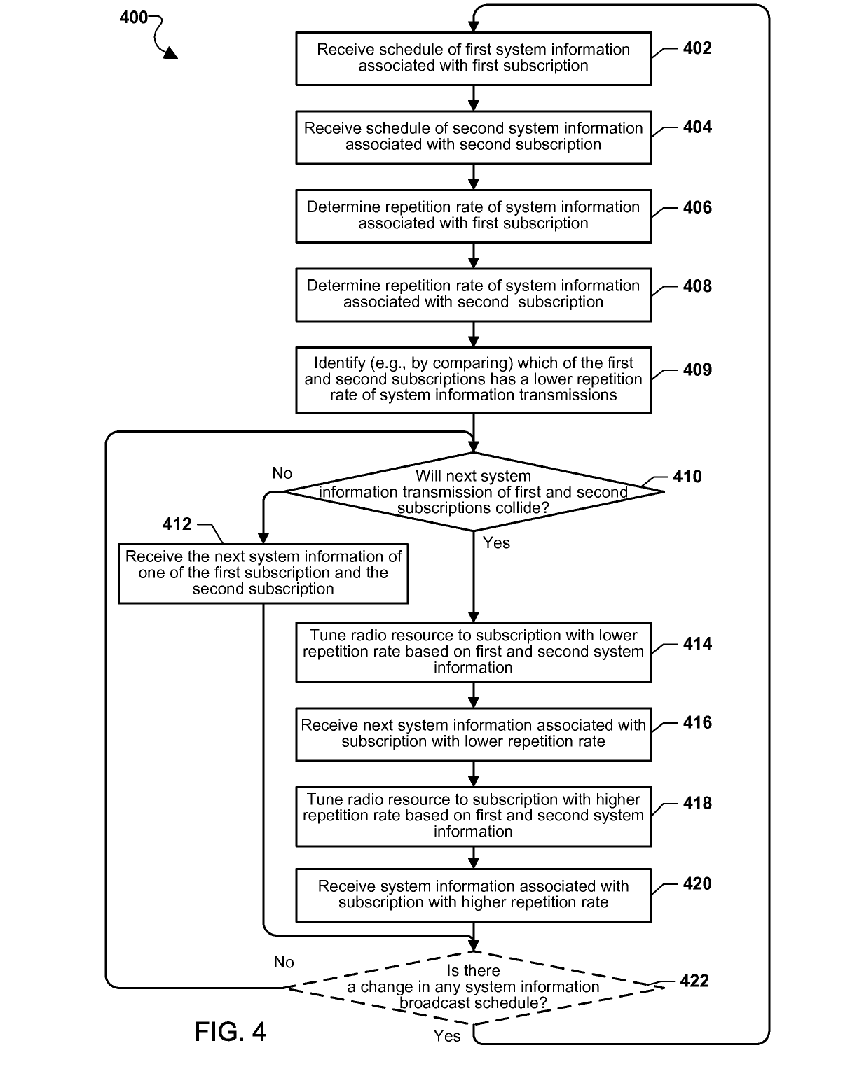

FIG. 4 illustrates a method 400 for decoding system information received by a processor of a multi-subscription multi-standby communication device according to some embodiments. With reference to FIGS. 1-4, the method 400 may be implemented by a device processor (e.g., the general-purpose processor 206, the baseband processor 216, a separate controller, and/or the like) of the multi-subscription multi-standby communication device (e.g., the multi-subscription multi-standby communication device 110, 200).

In block 402, the device processor may receive a schedule of first system information transmissions associated with a first subscription. In block 404, the device processor may receive a schedule of second system information transmissions associated with a second subscription. For example, the device processor may receive a master information block (MIB) or other similar schedule information from each of the first subscription and the second subscription. The schedules of the first system information and the second system information may include a schedule of transmissions of first and second system information, respectively

In block 406, the device processor may determine a repetition rate of the first system information transmissions based on the schedule of the first system information transmissions. In block 408, the device processor may determine a repetition rate of the system information transmissions associated with the second subscription based on the schedule of the second system information transmissions.

Using the schedules of the first and second system information transmissions (e.g., scheduled transmission times of the system information broadcasts of the first and second subscriptions), the device processor may identify the subscription with the lower repetition rate of system information transmissions, in block 409. For example, the device processor may compare the schedule of first system information transmissions and the schedule of second system information transmissions, and the device processor may identify, by comparing, which of the first and second subscriptions has a lower repetition rate of system information transmissions.

The scheduled transmission times of the system information transmissions of the first and second subscriptions may also enable the device processor to determine when the system information transmissions of the first and second subscriptions will collide. Thus, in determination block 410, the device processor may determine whether a next (i.e., next scheduled) system information transmission (broadcast) associated with the first and second subscriptions will collide (i.e., at least partially overlap in time).

In response to determining that the next scheduled system information transmissions of the first and second subscriptions will not collide (i.e., determination block 410=“No”), the device processor may receive the next system information associated with one of the first subscription and the second subscription, in block 412. For example, the device processor may perform a tune away to receive the system information of whichever of the first and second subscriptions is scheduled for transmission in block 412 in the ordinary fashion.

In response to determining that the next scheduled system information transmissions of the first and second subscription will collide (i.e., determination block 410=“Yes”), the device processor may tune the shared radio (i.e., RF) resource of the multi-subscription multi-standby communication device to the subscription with the lower repetition rate of system information transmissions, in block 414. Accordingly, the multi-subscription multi-standby communication device may receive the next system information for the subscription with the lower repetition rate, in block 416.

In block 418, the device processor may tune the radio resource to the subscription with the higher repetition rate based on the first and second system information (i.e., the subscription that does not have the lower repetition rate). In block 420, the device processor may then receive system information associated with the subscription with the higher repetition rate.

Optionally, the device processor may determine whether there is any change in the system information transmission schedules of the first subscription, the second subscription, or both subscriptions, in optional determination block 422. In response to determining that there is no change in any system information broadcast schedule (i.e., determination block 422=“No”), the device processor may again determine whether the next scheduled system information transmissions of the first and second subscriptions will collide, in determination block 410. In response to determining that there has been a change in one or more system information broadcast schedules (i.e., optional determination block 422=“Yes”), the device processor may repeat the operations of blocks 402-408 to identify the subscription with the lower system information broadcast repetition rate before continuing to monitor for system information broadcast collisions, in determination block 410.

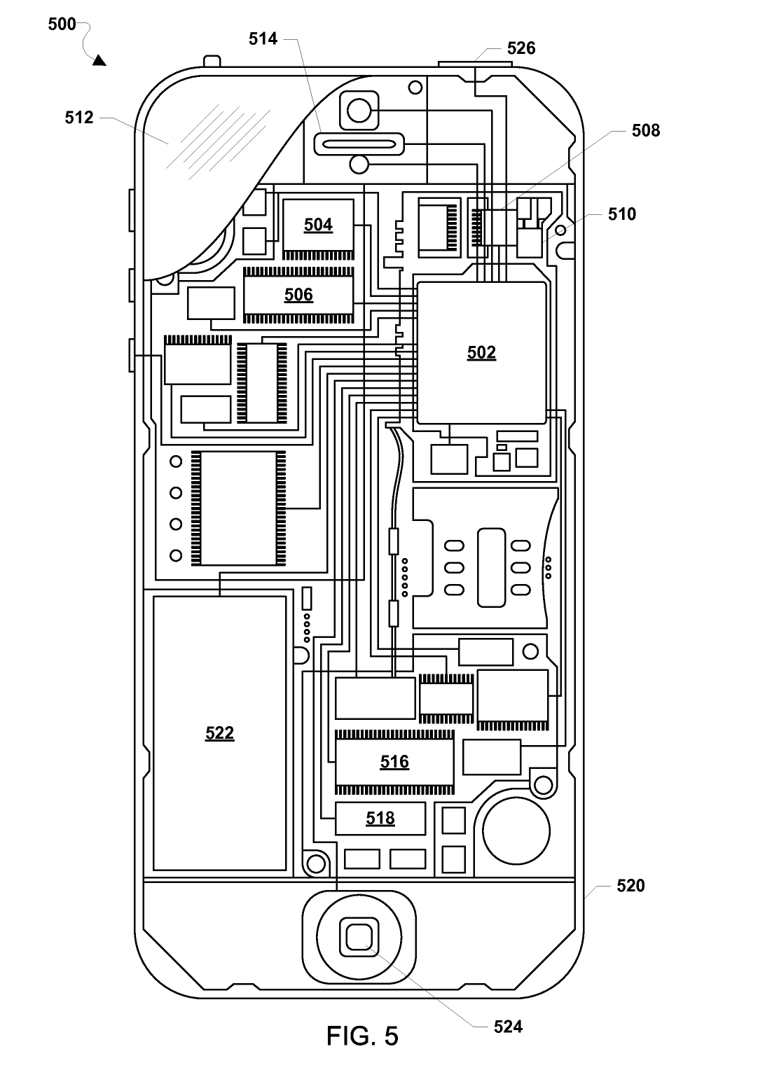

Various embodiments (including, but not limited to, embodiments described with reference to FIGS. 1-4) may be implemented in any of a variety of mobile communication devices, an example of which (e.g., mobile communication device 500) is illustrated in FIG. 5. With reference to FIGS. 1-5, a mobile communication device 500 (which may correspond, for example, to the multi-subscription multi-standby communication devices 110 and 200) may include a processor 502 coupled to a touchscreen controller 504 and an internal memory 506. The processor 502 may be one or more multi-core integrated circuits designated for general or specific processing tasks. The internal memory 506 may be volatile or non-volatile memory, and may also be secure and/or encrypted memory, or unsecure and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the mobile communication device 500 need not have touch screen capability.

The mobile communication device 500 may have two or more radio signal transceivers 508 (e.g., Peanut, Bluetooth, ZigBee, Wi-Fi, RF radio) and antennae 510, for sending and receiving communications, coupled to each other and/or to the processor 502. The transceivers 508 and antennae 510 may be used with the above-mentioned circuitry to implement the various wireless transmission protocol stacks and interfaces. The mobile communication device 500 may include one or more cellular network wireless modem chip(s) 516 coupled to the processor and antennae 510 that enable(s) communication via two or more cellular networks via two or more radio access technologies.

The mobile communication device 500 may include a peripheral device connection interface 518 coupled to the processor 502. The peripheral device connection interface 518 may be singularly configured to accept one type of connection, or may be configured to accept various types of physical and communication connections, common or proprietary, such as USB, FireWire, Thunderbolt, or PCIe. The peripheral device connection interface 518 may also be coupled to a similarly configured peripheral device connection port (not shown).

The mobile communication device 500 may also include speakers 514 for providing audio outputs. The mobile communication device 500 may also include a housing 520, constructed of a plastic, metal, or a combination of materials, for containing all or some of the components discussed herein. The mobile communication device 500 may include a power source 522 coupled to the processor 502, such as a disposable or rechargeable battery. The rechargeable battery may also be coupled to the peripheral device connection port to receive a charging current from a source external to the mobile communication device 500. The mobile communication device 500 may also include a physical button 524 for receiving user inputs. The mobile communication device 500 may also include a power button 526 for turning the mobile communication device 500 on and off.

The processor 502 may be any programmable microprocessor, microcomputer or multiple processor chip or chips that can be configured by software instructions (applications) to perform a variety of functions, including the functions of various embodiments described below. In some mobile communication devices, multiple processors 502 may be provided, such as one processor dedicated to wireless communication functions and one processor dedicated to running other applications. Typically, software applications may be stored in the internal memory 506 before they are accessed and loaded into the processor 502. The processor 502 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, the various embodiments are not intended to be limited to the embodiments shown herein but are to be accorded the widest scope consistent with the following claims and the principles and novel features disclosed herein.

What is claimed is:

1. A method for managing reception of system information transmissions from networks of a first subscription and a second subscription by a processor of a multi-subscription multi-standby communication device, the method comprising:
identifying one of the first subscription and the second subscription having a lower repetition rate of system information transmissions;
determining whether a next scheduled system information transmission by each of the first and second subscriptions will collide; and
receiving the next system information transmission from the one of the first subscription and the second subscription identified as having the lower repetition rate of system information transmissions in response to determining that the next scheduled system information transmission by each of the first and second subscriptions will collide.

2. The method of claim 1, wherein identifying which of the first subscription and the second subscription has a lower repetition rate of system information transmissions comprises:
receiving a schedule of first system information transmissions associated with the first subscription and a schedule of second system information transmissions associated with the second subscription;
determining a first repetition rate of first system information transmissions based on the schedule of first system information transmissions;
determining a second repetition rate of second system information transmissions associated with the second subscription based on the schedule of second system information transmissions; and
comparing the first repetition rate to the second repetition rate.

3. The method of claim 2, wherein the first repetition rate is different from the second repetition rate.

4. The method of claim 1, wherein receiving the next system information transmission from the one of the first subscription and the second subscription identified as having a lower repetition rate comprises tuning a shared radio frequency resource of the multi-subscription multi-standby communication device to the one of the first subscription and the second subscription for the next scheduled system information transmission.

5. The method of claim 1, wherein system information transmissions for the first subscription, the second subscription, or both comprise master information block (MIB) transmissions.

6. The method of claim 1, wherein system information transmissions for the first subscription, the second subscription, or both comprise system information block (SIB) transmissions.

7. The method of claim 1, further comprising:
receiving the next system information transmission from one of the first subscription and the second subscription in response to determining that the next scheduled system information transmission by each of the first and second subscriptions will not collide.

8. The method of claim 1, wherein determining whether a next scheduled system information transmission by each of the first and second subscriptions will collide comprises determining whether a next scheduled system information transmission by each of the first and second subscriptions will at least partially overlap in time.

9. The method of claim 1, wherein identifying one of the first subscription and the second subscription having a lower repetition rate of system information transmissions comprises identifying which of the first subscription and the second subscription transmits system information less frequently.

10. The method of claim 1, further comprising:
receiving the next system information transmission from the one of the first subscription and the second subscription having the higher repetition rate of system information transmissions than the one of the first subscription and the second subscription identified as having the lower repetition rate of system information transmissions.

11. The method of claim 1, wherein identifying one of the first subscription and the second subscription having a lower repetition rate of system information transmissions comprises identifying which of a plurality of subscriptions has a lowest repetition rate of system information transmissions.

12. The method of claim 11, wherein determining whether a next scheduled system information transmission by each of the first and second subscriptions will collide comprises determining whether a next scheduled system information transmission by any two of the plurality of subscriptions will collide.

13. The method of claim 12, wherein receiving the next system information transmission from the one of the first subscription and the second subscription identified as having the lower repetition rate of system information transmissions in response to determining that the next scheduled system information transmission by each of the first and second subscriptions will collide comprises receiving the next system information transmission from a subscription from among the any two of the plurality of subscriptions having a relatively lower repetition rate of system information transmissions.

14. A multi-subscription multi-standby communication device, comprising:
a memory;
a radio frequency (RF) chain; and
a processor coupled to the memory and the RF chain and configured to:
identify which of a first subscription and a second subscription has a lower repetition rate of system information transmissions;
determine whether a next scheduled system information transmission by each of the first and second subscriptions will collide; and
receive the next system information transmission from the one of the first subscription and the second subscription identified as having the lower repetition rate of system information transmissions in response to determining that the next scheduled system information transmission by each of the first and second subscriptions will collide.

15. The multi-subscription multi-standby communication device of claim 14, wherein the processor is further configured to identify which of the first subscription and the second subscription has a lower repetition rate of system information transmissions by:
receiving a schedule of first system information transmissions associated with the first subscription and a schedule of second system information transmissions associated with the second subscription;
determining a first repetition rate of first system information transmissions based on the schedule of first system information transmissions;
determining a second repetition rate of second system information transmissions associated with the second subscription based on the schedule of second system information transmissions; and
comparing the first repetition rate to the second repetition rate.

16. The multi-subscription multi-standby communication device of claim 15, wherein the processor is further configured such that the first repetition rate is different from the second repetition rate.

17. The multi-subscription multi-standby communication device of claim 14, wherein the processor is further configured to tune a shared radio frequency resource of the multi-subscription multi-standby communication device to the one of the first subscription and the second subscription for the next scheduled system information transmission.

18. The multi-subscription multi-standby communication device of claim 14, wherein system information transmissions for the first subscription, the second subscription, or both comprise master information block (MIB) transmissions.

19. The multi-subscription multi-standby communication device of claim 14, wherein system information transmissions for the first subscription, the second subscription, or both comprise system information block (SIB) transmissions.

20. The multi-subscription multi-standby communication device of claim 14, wherein the processor is further configured to:
receive the next system information transmission from one of the first subscription and the second subscription in response to determining that the next scheduled system information transmission by each of the first and second subscriptions will not collide.

21. The multi-subscription multi-standby communication device of claim 14, wherein the processor is further configured to determine whether a next scheduled system information transmission by each of the first and second subscriptions will at least partially overlap in time.

22. The multi-subscription multi-standby communication device of claim 14, wherein the processor is further configured to identify which of the first subscription and the second subscription transmits system information less frequently.

23. The multi-subscription multi-standby communication device of claim 14, wherein the processor is further configured to:
receive the next system information transmission from the one of the first subscription and the second subscription having the higher repetition rate of system information transmissions than the one of the first subscription and the second subscription identified as having the lower repetition rate of system information transmissions.

24. The multi-subscription multi-standby communication device of claim 23, wherein the processor is further configured to identify which of a plurality of subscriptions has a lowest repetition rate of system information transmissions.

25. The multi-subscription multi-standby communication device of claim 24, wherein the processor is further configured to determine whether a next scheduled system information transmission by any two of the plurality of subscriptions will collide.

26. The multi-subscription multi-standby communication device of claim 25, wherein the processor is further configured to receive the next system information transmission from a subscription from among the any two of the plurality of subscriptions having a relatively lower repetition rate of system information transmissions.

27. A non-transitory processor-readable storage medium having stored thereon processor-executable software instructions configured to cause a processor of a multi-subscription multi-standby communication device having a plurality of radio frequency (RF) chains to perform operations comprising:
identifying which of a first subscription and a second subscription has a lower repetition rate of system information transmissions;
determining whether a next scheduled system information transmission by each of the first and second subscriptions will collide; and
receiving the next system information transmission from the one of the first subscription and the second subscription identified as having the lower repetition rate of system information transmissions in response to determining that the next scheduled system information transmission by each of the first and second subscriptions will collide.

28. The non-transitory processor-readable storage medium of claim 27, wherein the stored processor-executable software instructions are configured to cause the processor to perform operations such that identifying which of the first subscription and the second subscription has a lower repetition rate of system information transmissions comprises:
receiving a schedule of first system information transmissions associated with the first subscription and a schedule of second system information transmissions associated with the second subscription;
determining a first repetition rate of first system information transmissions based on the schedule of first system information transmissions;
determining a second repetition rate of second system information transmissions associated with the second subscription based on the schedule of second system information transmissions; and
comparing the first repetition rate to the second repetition rate.

29. The non-transitory processor-readable storage medium of claim 27, wherein the stored processor-executable software instructions are configured to cause the processor to perform operations such that receiving the next system information transmission from the one of the first subscription and the second subscription identified as having a lower repetition rate comprises tuning a shared radio frequency resource of the multi-subscription multi-standby communication device to the one of the first subscription and the second subscription during the next scheduled system information transmission.

30. A multi-subscription communication device, comprising:
means for identifying which of a first subscription and a second subscription has a lower repetition rate of system information transmissions;
means for determining whether a next scheduled system information transmission by each of the first and second subscriptions will collide; and
means for receiving the next system information transmission from the one of the first subscription and the second subscription identified as having a lower repetition rate in response to determining that the next scheduled system information transmission by each of the first and second subscriptions will collide.
